(19) United States
(12) Patent Application Publication
(10) Pub. No.: US 2022/0397214 A1
(43) Pub. Date: Dec. 15, 2022

(54) GUIDING DEVICE FOR LONG OBJECT

(71) Applicant: TSUBAKIMOTO CHAIN CO., Osaka-shi, Osaka (JP)

(72) Inventors: Yasutaka Tanaka, Osaka-shi (JP); Masashi Kunii, Osaka-shi (JP)

(73) Assignee: TSUBAKIMOTO CHAIN CO., Osaka-shi, Osaka (JP)

(21) Appl. No.: 17/785,210

(22) PCT Filed: Dec. 7, 2020
(86) PCT No.: PCT/JP2020/045461

§ 371 Date: Jun. 14, 2022

(30) Foreign Application Priority Data
Dec. 17, 2019 (JP) 2019-226958

(51) Int. Cl. F16L 3/015

(52) U.S. Cl. CPC F16L 3/015

(57) ABSTRACT

A long object guiding device includes a belt-shaped unit that includes flexible and elongated tubular members. The tubular members are arranged side by side. Adjacent ones of the tubular members are coupled together so that all the tubular members are integrated. The tubular members include at least one protective tubular member. The protective tubular member is configured to accommodate a long object. The protective tubular member includes a first joint portion and a second joint portion. The first joint portion is formed to extend in a longitudinal direction of the protective tubular member. The second joint portion is formed to extend in the longitudinal direction. The second joint portion is configured to be joined to and disjoined from the first joint portion.

### TECHNICAL FIELD

The present disclosure relates to a long object guiding device that accommodates a long object that is, for example, a flexible cable for feeding power to or a hose for feeding fluid to a movable unit in a machine tool or the like, and guides the long object in accordance with movement of the movable unit while protecting the long object.

### BACKGROUND ART

Conventionally, Patent Literature 1 discloses an example of such a long object guiding device. This long object guiding device includes a belt-shaped unit that includes flexible tubular members. The tubular members are arranged side by side. Adjacent ones of the tubular members are coupled together so that all the tubular members are integrated. Each tubular member is made of plastic and has a shape of an elongated cylinder. The tubular members, which form the belt-shaped unit, include ones at opposite sides in the arrangement direction. The tubular members at the opposite sides each accommodate a long articulated supporting member. The articulated supporting member is allowed to bend toward one side in a direction intersecting with its longitudinal direction within a range up to a set bend radius, while being restricted from bending to the side opposite to the bending side. The tubular members other than the ones at the opposite sides, which accommodate the articulated supporting members, accommodate coated wires, which are long objects. Each coated wire includes an electric wire and an insulating material coating the electric wire.

### CITATION LIST

### Patent Literature

Patent Literature 1: Japanese Laid-Open Patent Publication No. 2016-205572

### SUMMARY OF INVENTION

### Technical Problem

In the above-described conventional long object guiding device, when one of the coated wires needs to be replaced, for example, due to a break of the electric wire, not only that coated wire alone, but also the entire belt-shaped unit, which includes the other coated wires and tubular members, need to be replaced. This increases the costs for replacing long objects such as coated wires.

It is an objective of the present disclosure to provide a long object guiding device that reduces costs for replacing a long object accommodated in a tubular member of a belt-shaped unit.

### Solution to Problem

Means and operational advantages for solving the above-described problem will now be described.

To achieve the foregoing objective, a long object guiding device is provided that includes a belt-shaped unit that includes flexible and elongated tubular members. The tubular members are arranged side by side. Adjacent ones of the tubular members are coupled together so that all the tubular members are integrated. The long object guiding device is configured to accommodate a flexible long object in at least one of the tubular members, and guide the long object while protecting the long object with the tubular member as the belt-shaped unit is displaced. The tubular members include at least one protective tubular member. The protective tubular member is configured to accommodate the long object. The protective tubular member includes a first joint portion and a second joint portion. The first joint portion is formed to extend in a longitudinal direction of the protective tubular member. The second joint portion is formed to extend in the longitudinal direction. The second joint portion is configured to be joined to and disjoined from the first joint portion.

With this configuration, when the long object accommodated in one of the protective tubular members of the belt-shaped unit needs to be replaced, an opening extending in the longitudinal direction is formed in that protective tubular member when the first joint portion and the second joint portion, which extend in the longitudinal direction of the protective tubular member, are disjoined from each other. This allows that long object alone, which requires replacement, to be replaced through the opening. That is, the entire belt-shaped unit, which includes the long objects in addition to the one requiring replacement and the tubular members, does not need to be replaced as a whole. This reduces the costs for replacing a long object accommodated in a protective tubular member of the belt-shaped unit.

In the above-described long objective guiding device, the first joint portion is a groove that extends in the longitudinal direction. The second joint portion is a protrusion that extends in the longitudinal direction. The protrusion is configured to be mated with and unmated from the groove.

This configuration easily achieves a mated state of the groove and the protrusion, which is the joined state of the first joint portion and the second joint portion. The configuration also allows the groove and the protrusion to be easily unmated from each other.

In the above-described long object guiding device, the belt-shaped unit includes a first end portion and a second end portion in a longitudinal direction of the belt-shaped unit. The first end portion is a fixed end. The second end portion is a movable end that moves in a guiding direction. The guiding direction is a direction in which the long object is guided while being protected by the protective tubular member. The belt-shaped unit includes a bent portion between the first end portion and the second end portion. The bent portion is displaced in the guiding direction as the second end portion moves. The groove and the protrusion are provided in a part of the protective tubular member that is at an inner periphery of the bent portion.

With this configuration, the groove and the protrusion of the protective tubular member are mated with each other at the inner periphery of the bent portion. Thus, when the bent portion is displaced as the second end portion of the belt-shaped unit moves, the mated state of the groove and the protrusion are less easily unmated than in a case in which the groove and the protrusion are mated together at the outer periphery. Also, the groove and the protrusion are restricted from contacting peripheral devices located near the outer periphery of the bent portion.

In the above-described long object guiding device, a holding member is attached to the protective tubular member. The holding member is engaged with the mated groove and protrusion so as to maintain a mated state of the groove and the protrusion.

This configuration prevents the mated groove and protrusion from being unintentionally unmated from each other by an external force, for example, when the bent portion is displaced.

In the above-described long object guiding device, the holding member is an elongated member that extends in the longitudinal direction of the protective tubular member.

With this configuration, the holding member, which is provided to extend along the protective tubular member in the longitudinal direction, supports the part of the belt-shaped unit between the bent portion and the second end portion and prevents this part from sagging under its own weight.

In the above-described long object guiding device, the tubular members include two supporting tubular members. The two supporting tubular members are located on opposite sides in an arrangement direction of the tubular members. Each supporting tubular member accommodates an articulated supporting member. Each articulated supporting member includes link members. The link members are arranged in series. Adjacent ones of the link members are pivotally coupled to each other. Each articulated supporting member is allowed to pivot toward one side in a direction intersecting with a series arrangement direction within a range up to a set bend radius, while being restricted from pivoting to an other side that is opposite to the one side. The tubular members, except for the supporting tubular members which are located on the opposite sides in the arrangement direction, include the at least one protective tubular member.

With this configuration, the supporting tubular members are located at the opposite sides in the arrangement direction and accommodate the articulated supporting members, which are not required to be replaced. The supporting tubular members are not opened when a long object is replaced. This facilitates replacement of the long object.

### Advantageous Effects of Invention

The present disclosure reduces costs for replacing a long object accommodated in a tubular member of a belt-shaped unit.

### BRIEF DESCRIPTION OF DRAWINGS

FIG. 1 is a perspective view, with a part cut away, showing a long object guiding device according to one embodiment.

FIG. 2 is a cross-sectional view taken along line 2-2 in FIG. 1.

FIG. 3 is a side view schematically illustrating a use state of the long object guiding device.

FIG. 4 is a cross-sectional view of a belt-shaped unit, illustrating a state in which a long object is being replaced.

FIG. 5 is a perspective view, with a part cut away, showing a long object guiding device according to a first modification.

FIG. 6 is a cross-sectional view of a belt-shaped unit in a long object guiding device according to a second modification.

FIG. 7 is a cross-sectional view of a belt-shaped unit in a long object guiding device according to a third modification.

### DESCRIPTION OF EMBODIMENTS

A long object guiding device according to one embodiment will now be described with reference to the drawings.

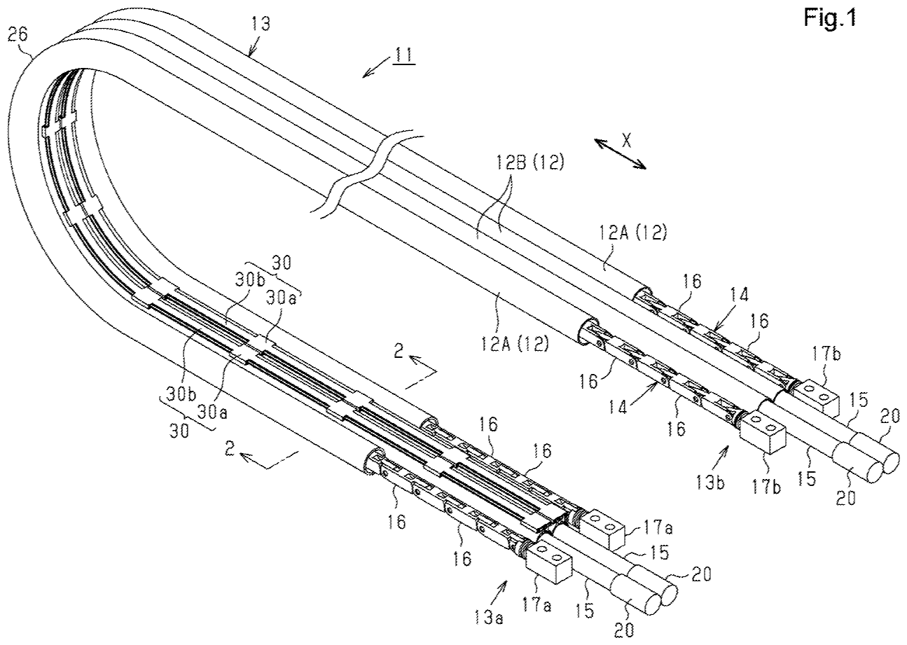

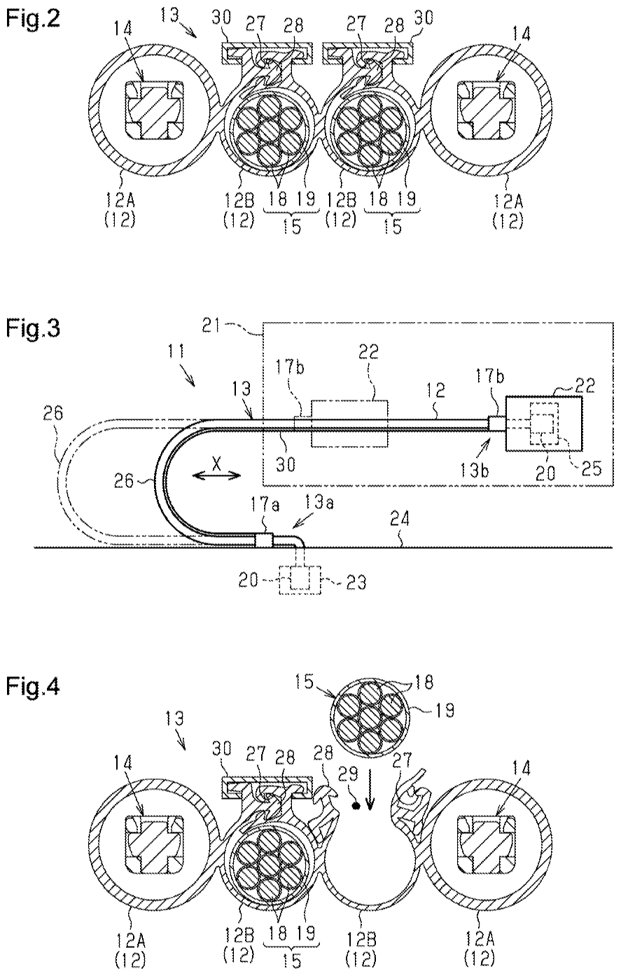

As shown in FIGS. 1 and 2, a long object guiding device 11 includes a belt-shaped unit 13 that includes flexible tubular members 12. The tubular members 12 are arranged side by side, and adjacent ones of the tubular members 12 are coupled together by welding so as to be integrated to form the belt-shaped unit 13. Each tubular member 12 is made of plastic and has a shape of an elongated cylinder. In the present embodiment, the belt-shaped unit 13 is formed by four tubular members 12. The four tubular members 12 include two tubular members 12 that are located at opposite sides in an arrangement direction and respectively accommodate articulated supporting members 14. The four tubular members 12 also include center two tubular members 12 other than the tubular members 12 at the opposite sides. The center two tubular members 12 respectively accommodate cables 15, which are long objects. That is, among the four tubular members 12, the two tubular members 12 at the opposite sides in the arrangement direction are supporting tubular members 12A configured to accommodate the articulated supporting members 14. Also, among the four tubular members 12, the center two tubular members 12 other than the tubular members 12 at the opposite sides (the supporting tubular members 12A) are protective tubular members 12B configured to accommodate long objects.

Each articulated supporting member 14 includes link members 16 arranged in series. Adjacent ones of the link members 16 are pivotally coupled to each other. Each articulated supporting member 14 is allowed to bend toward one side in a direction intersecting with its longitudinal direction, which is a series arrangement direction, within a range up to a set bend radius, while being restricted from bending to the other side, which is opposite to the bending side. As shown in FIG. 1, a first fixing member 17a is attached to a first end portion in the longitudinal direction of each articulated supporting member 14. A second fixing member 17b is attached to a second end portion in the longitudinal direction of each articulated supporting member 14.

As shown in FIG. 2, each cable 15 includes multiple, for example seven, bundled electric wires 18, and an elongated cylindrical insulating material 19 that coats the electric wires 18. The cables 15 have an outer diameter smaller than the inner diameter of the protective tubular members 12B of the belt-shaped unit 13 so as to be inserted into the protective tubular members 12B. As shown in FIG. 1, a cylindrical connector member 20 is attached to each of the end portions of the cables 15 projecting from the opposite ends of the protective tubular members 12B. The connector members 20 have an outer diameter larger than the inner diameter of the protective tubular members 12B. That is, in the long object guiding device 11 of the present embodiment, the cables 15 can be inserted into the protective tubular members 12B of the belt-shaped unit 13, but the connector members 20, which are attached to the ends of the cables 15, cannot be inserted into the protective tubular members 12B.

As shown in FIG. 3, a facility 21 such as a machine tool includes a movable unit 22. The cables 15 are routed to supply power from a predetermined power source 23 to the movable unit 22 of the facility 21, and the long object guiding device 11 is used to guide the cables 15 in accordance with movement of the movable unit 22 while protecting the cables 15. The belt-shaped unit 13 includes a first end portion 13a and a second end portion 13b in its longitudinal direction. The first end portion 13a of the belt-shaped unit 13 is a fixed end and corresponds to the first fixing members 17a attached to the articulated supporting members 14. The second end portion 13b of the belt-shaped unit 13 is a movable end, which moves in a guiding direction X, and corresponds to the second fixing members 17b attached to the articulated supporting members 14. The guiding direction X corresponds to a direction in which the cables 15 are guided by the protective tubular members 12B while being protected.

That is, the belt-shaped unit 13 is configured such that the first fixing members 17a at the first end portions of the articulated supporting members 14 are fixed to predetermined positions on an installation surface 24, which extends parallel with the guiding direction X. Also, the belt-shaped unit 13 is configured such that the connector members 20 of the cables 15 project from the ends of the protective tubular members 12B at the first end portion 13a in the longitudinal direction, and the connector members 20 are connected to the power source 23 in the installation surface 24. On the other hand, the belt-shaped unit 13 is configured such that the second fixing members 17b at the second end portions of the articulated supporting members 14 are fixed to the movable unit 22 of the facility 21. Further, the belt-shaped unit 13 is configured such that the connector members 20 of the cables 15 project from the ends of the protective tubular members 12B at the second end portion 13b in the longitudinal direction, and the connector members 20 are connected to an electrical device 25, which is arranged inside the movable unit 22.

As shown in FIGS. 1 and 3, the belt-shaped unit 13 includes a bent portion 26 between the first end portion 13a and the second end portion 13b along the longitudinal length thereof. The bent portion 26 is formed such that the first end portion 13a is located between the bent portion 26 and the second end portion 13b in the guiding direction X, which is the moving direction of the movable unit 22. The bent portion 26 has a semi-circular shape bulging away from the second end portion 13b. A part of the belt-shaped unit 13 between the first end portion 13a and the bent portion 26 extends along the installation surface 24. A part of the belt-shaped unit 13 between the second end portion 13b and the bent portion 26 is arranged at a height at which the movable unit 22 moves and extends parallel with the installation surface 24. The belt-shaped unit 13 is configured such that as the second end portion 13b moves together with the movable unit 22 of the facility 21, the bent portion 26 is displaced in the guiding direction X, which is a moving direction of the movable unit 22.

As shown in FIGS. 2 and 4, the tubular members 12 of the belt-shaped unit 13 include the tubular members 12 that accommodate the cables 15, that is, the protective tubular members 12B. The protective tubular members 12B each include a groove 27 and a protrusion 28. The grooves 27 and the protrusions 28 each extend in the longitudinal direction of the protective tubular members 12B. In each protective tubular member 12B, the groove 27 and the protrusion 28 are adjacent to each other in the circumferential direction of the protective tubular members 12B. In the present embodiment, the groove 27 corresponds to a first joint portion, and the protrusion 28 corresponds to a second joint portion. The groove 27 and the protrusion 28 are integrally formed with the plastic protective tubular members 12B by extrusion and can be mated with and unmated from each other. The protective tubular member 12B is configured to have a shape of an elongated cylinder when the groove 27 and the protrusion 28 are mated with each other. The protective tubular member 12B is configured to have an opening 29, which extends in the longitudinal direction of the protective tubular member 12B, between the groove 27 and the protrusion 28 when the groove 27 and the protrusion 28 are unmated from each other. In the present embodiment, the groove 27 and the protrusion 28 are provided in a part of each protective tubular member 12B that is at the inner periphery of the bent portion 26.

When an external force is applied to the protective tubular member 12B in a state in which the groove 27 and the protrusion 28 are mated with each other, the groove 27 and the protrusion 28 may be unintentionally unmated from each other. To deal with this drawback, a holding member 30 is attached to each protective tubular member 12B as shown in FIGS. 1 and 2. The holding member 30 is engaged with the mated groove 27 and protrusion 28 so as to maintain the mated state of the groove 27 and the protrusion 28. The holding member 30 is an elongated member including hooks 30a and elongated plate-shaped coupling portions 30b. The hooks 30a are engaged with the mated groove 27 and protrusion 28 from the outer side so as to prevent the groove 27 and the protrusion 28 from being unmated from each other. The hooks 30a are positioned at predetermined intervals in the longitudinal direction of the protective tubular members 12B. The coupling portions 30b couple the hooks 30a to each other. In the present embodiment, the groove 27 and the protrusion 28 are provided in a part of each protective tubular member 12B that is at the inner periphery of the bent portion 26. Accordingly, the elongated plate-shaped holding member 30 is arranged in a part of the protective tubular members 12B that is at the inner periphery of the bent portion 26 as shown FIGS. 1 and 3.

Operation of the long object guiding device 11, which has the above-described configuration, will now be described.

When the movable unit 22 of the facility 21 moves in the guiding direction X from a position indicated by the solid lines to a position indicated by the long-dash double-short-dash lines in FIG. 3, the bent portion 26 of the belt-shaped unit 13 in the long object guiding device 11 is displaced in the guiding direction X from a position indicated by the solid lines to a position indicated by the long-dash double-short-dash lines. At this time, the grooves 27 and the protrusions 28, which are formed to extend in the longitudinal direction of the circumferential surface of the protective tubular members 12B in the belt-shaped unit 13, receive an external bending force when being bent as parts of the bent portion 26.

In such a case, the external force acting on the mated groove 27 and protrusion 28 may unintentionally unmate the groove 27 and the protrusion 28 from each other, depending on the direction of the external force. For example, it is assumed that the groove 27 and the protrusion 28 are formed in a part of the bent portion 26 that is at the outer periphery. When the belt-shaped unit 13 is bent, the outer periphery of the bent portion 26 is longer than the inner periphery. Such a difference in the lengths produces an external bending force acting in a direction unmating the groove 27 and the protrusion 28 from each other. However, in the present embodiment, the groove 27 and the protrusion 28, which are formed to extend in the longitudinal direction on the circumferential surface of the protective tubular members 12B, are formed in a part that is located at the inner periphery of the bent portion 26 when being bent as part of the bent portion 26. Thus, when the mated part of the mated groove 27 and protrusion 28 is bent as a part of the bent portion 26, an external force is produced that pushes the groove 27 and the protrusion 28 against each other so that the groove 27 and the protrusion 28 are firmly mated. The groove 27 and the protrusion 28 are thus not easily unmated from each other.

If the groove 27 and the protrusion 28 are formed in a part that is located at the outer periphery of the bent portion 26 of the belt-shaped unit 13 when the bent portion 26 is displaced in the guiding direction X, the groove 27 and the protrusion 28 may contact peripheral devices located near the outer periphery of the bent portion 26. Such contact with the peripheral devices may cause the mated groove 27 and protrusion 28 to be unmated from each other. However, since the groove 27 and the protrusion 28 are formed in a section at the inner periphery of the bent portion 26 in the present embodiment, such contact with the peripheral devices does not occur.

Further, even when the bent portion 26 of the belt-shaped unit 13 is not being displaced, an external force that acts to unmate the groove 27 and the protrusion 28 in the protective tubular member 12B from each other can act on the groove 27 and the protrusion 28. If such an external force unmates the groove 27 and the protrusion 28 from each other, the cable 15 will protrude from the protective tubular member 12B. This can hamper smooth operation of the long object guiding device 11.

However, the present embodiment includes the holding member 30, which includes the hooks 30a. The hooks 30a are engaged with the mated groove 27 and protrusion 28 so as to maintain the mated state of the groove 27 and the protrusion 28 as shown in FIGS. 1 and 2. This reduces the possibility that the groove 27 and the protrusion 28 will be unmated from each other by an unexpected external force.

Further, the holding member 30 has a shape of an elongated plate with the hooks 30a being coupled together by the thin plate-shaped coupling portions 30b. The holding member 30 is put on the protective tubular member 12B in the belt-shaped unit 13 in the longitudinal direction of the protective tubular members 12B from the inner side of the bent portion 26. Thus, within the horizontal part of the belt-shaped unit 13 between the bent portion 26 and the second end portion 13b, which is a movable end, a part that corresponds to the protective tubular members 12B is supported from below by the elongated plate-shaped holding member 30, which serves as a splint. The supported part is thus prevented from sagging under its own weight.

During the use of the long object guiding device 11, if the cable 15 accommodated in one of the protective tubular members 12B of the belt-shaped unit 13 breaks, the broken cable 15 needs to be replaced by a new cable 15. In such a case, if the connector members 20, which have an outer diameter larger than the inner diameter of protective tubular members 12B, are attached to the ends projecting from the opposite ends of the protective tubular members 12B, as in the case of the cables 15 of the present embodiment, then the connector members 20 at the ends of the cables 15 cannot be inserted into the protective tubular members 12B. Therefore, it is impossible to replace the broken cable 15 alone. That is, instead of replacing the broken cable 15 alone, the entire belt-shaped unit 13, which includes the other cable 15 and the tubular members 12, need to be replaced. However, the present embodiment has the following configuration to deal with such a drawback.

That is, in the protective tubular member 12B of which the cable 15 needs to be replaced, the holding member 30 is removed from the mated groove 27 and protrusion 28. The groove 27 and the protrusion 28 are then unmated from each other as shown in FIG. 4. This creates a long opening 29 between the groove 27 and the protrusion 28 in the protective tubular member 12B as shown in FIG. 4. The opening 29 extends in the longitudinal direction. The broken old cable 15 is removed from the protective tubular member 12B through the opening 29. Subsequently, a new cable 15 is accommodated in the protective tubular member 12B through the opening 29 as shown in FIG. 4. Thereafter, the holding member 30 is attached to the groove 27 and the protrusion 28 in a mated state. Replacement of the broken cable 15 is thus completed.

Further, the cable 15 has, at the opposite ends, the connector members 20, which have a larger outer diameter than the inner diameter of the protective tubular member 12B. However, when replacing the cable 15, it is possible to remove the broken cable 15 from and place the new cable 15 into the protective tubular member 12B through the opening 29 without inserting the connector member 20 into the protective tubular member 12B. Replacement of the entire belt-shaped unit 13 is therefore not necessary. That is, the present embodiment requires replacement of only the broken cable 15 and therefore requires less costs than a case in which the entire belt-shaped unit 13 needs to be replaced.

The above-described embodiment has the following advantages.

(1) When the cable 15 accommodated in one of the tubular members 12 (the protective tubular member 12B) of the belt-shaped unit 13 needs to be replaced, the opening 29 extending in the longitudinal direction is formed in the protective tubular member 12B by unmating the groove 27 and the protrusion 28, which extend in the longitudinal direction of the protective tubular member 12B, from each other. Therefore, the cable 15 that needs replacement can be replaced alone through the opening 29. That is, the belt-shaped unit 13, which includes the cable 15 in addition to the cable 15 requiring replacement and the tubular members 12, does not need to be replaced as a whole. This reduces the costs for replacing the cable 15 accommodated in the tubular members 12 (the protective tubular members 12B) of the belt-shaped unit 13.

(2) The first joint portion and the second joint portion respectively include the groove 27 and the protrusion 28, which are made of plastic and can be mated. The above-described embodiment therefore easily achieves a mated state, which is a joined state of the first joint portion and the second joint portion. The above-described embodiment also easily unmates the first joint portion and the second joint portion from each other.

(3) When the bent portion 26 is displaced as the second end portion 13b of the belt-shaped unit 13 moves, the groove 27 and the protrusion 28 of each protective tubular member 12B are in a mated state at the inner periphery of the bent portion 26. The groove 27 and the protrusion 28 are thus less likely to be unmated from each other than in a case in which the groove 27 and the protrusion 28 are mated at the outer periphery. Also, the groove 27 and the protrusion 28 are prevented from contacting peripheral devices near the outer periphery of the bent portion 26.

(4) The groove 27 and the protrusion 28 of each protective tubular member 12B are mated at the inner periphery of the bent portion 26. This prevents the mated groove 27 and protrusion 28 from being unintentionally unmated from each other by an external force, for example, when the bent portion 26 is displaced.

(5) The holding member 30, which is put on each protective tubular member 12B to extend in the longitudinal direction, supports the part of the belt-shaped unit 13 between the bent portion 26 and the second end portion 13b and prevents this part from sagging under its own weight.

(6) The tubular members 12 in the belt-shaped unit 13 at the opposite sides in the arrangement direction (the supporting tubular members 12A) accommodate the articulated supporting members 14. When a cable 15 is replaced, the supporting tubular members 12A are not opened. This facilitates replacement of the cable 15.

The above-described embodiment may be modified as follows. The features included in the above-described embodiment and the features included in the following modifications can be combined. Also, the features included in the following modifications can be combined.

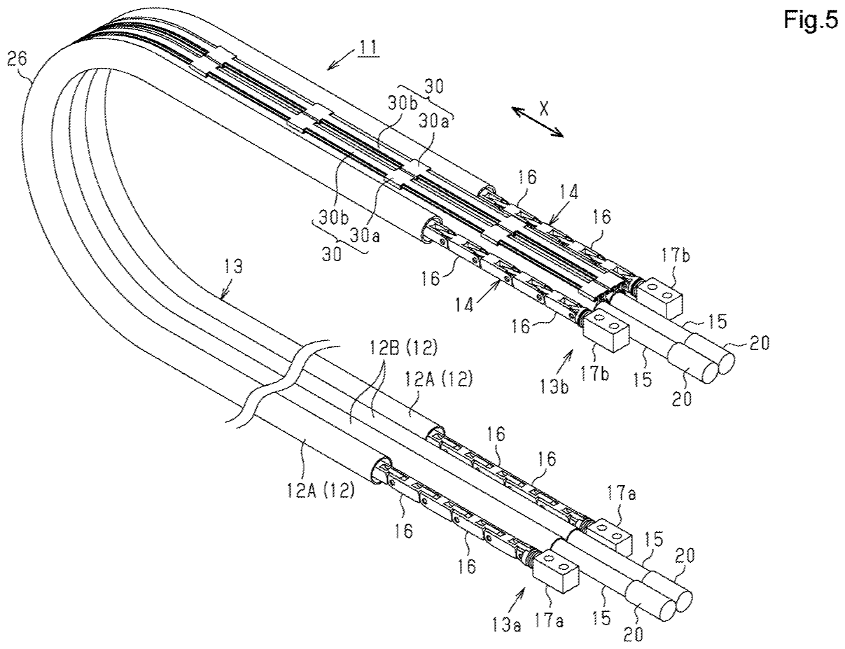

As in a first modification shown in FIG. 5, the groove 27 and the protrusion 28 may be provided in a part of the protective tubular members 12B that is at the outer periphery of the bent portion 26. If the groove 27 and the protrusion 28 are located at the outer periphery of the bent portion 26, the groove 27 and the protrusion 28 can be easily unmated from each other, and the cable 15 can be easily removed from or inserted into the protective tubular member 12B through the opening 29. Further, if the groove 27 and the protrusion 28 are provided in a part of the protective tubular member 12B that is at the inner periphery of the bent portion 26, unlike the first modification, aging deterioration due to the difference between the lengths at the inner periphery and the outer periphery of the bent portion 26 will cause the inner periphery to wrinkle. If such a wrinkled part is bent, the groove 27 and the protrusion 28 may be unmated from each other. However, since the groove 27 and the protrusion 28 are provided in a part of the protective tubular member 12B that is at the outer periphery of the bent portion 26, the first modification reduces the possibility that the groove 27 and the protrusion 28 will be unmated when such bending occurs.

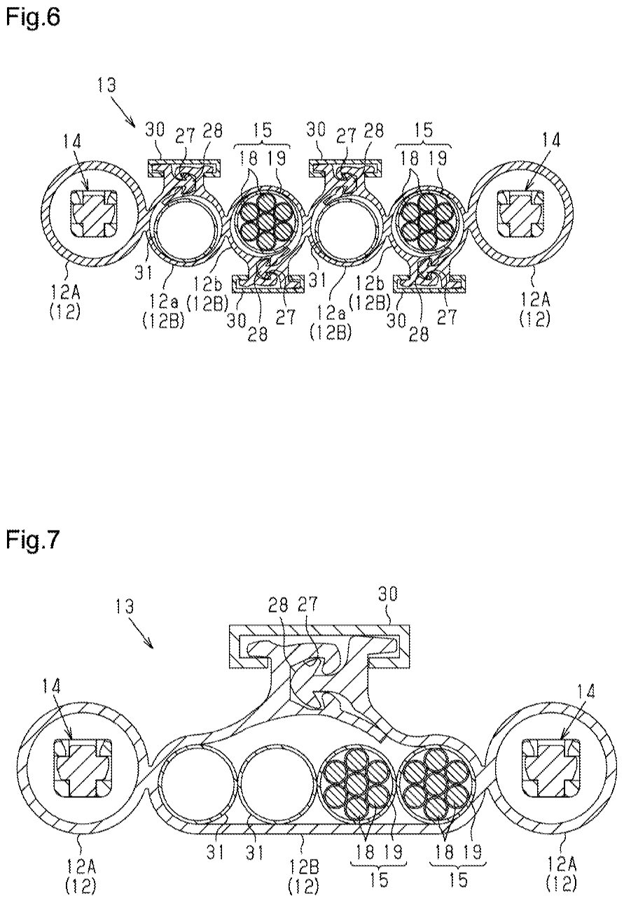

FIG. 6 illustrates a belt-shaped unit 13 according to a second modification that includes tubular members 12. The tubular members 12 include protective tubular members 12B, which include first protective tubular members 12a and second protective tubular members 12b. The first protective tubular members 12a each include a groove 27 and a protrusion 28 at the inner periphery of the bent portion 26. The second protective tubular members 12b each include a groove 27 and a protrusion 28 at the outer periphery of the bent portion 26. Specifically, the belt-shaped unit 13 includes the first protective tubular members 12a and the second protective tubular members 12b, the total number of which is four. The first protective tubular members 12a and the second protective tubular members 12b are arranged alternately in the arrangement direction of the first protective tubular members 12a and the second protective tubular members 12b. In this configuration, every other tubular member 12 in the arrangement direction of the tubular members 12 is provided with a mated portion of the groove 27 and the protrusion 28 either at the inner periphery or the outer periphery of the bent portion 26. This facilitates mating and unmating of the groove 27 and the protrusion 28. In the second modification shown in FIG. 6, a fluid feeding hose 31, which is a long object, is accommodated in each first protective tubular member 12a, and a power feeding cable 15, which is a long object, is accommodated in each second protective tubular members 12b. The holding members 30 may be attached to all the mated portions at the inner periphery and the outer periphery of the belt-shaped unit 13 in a bent state. Alternately, the holding members 30 may be attached to the mated portions only at the inner periphery or the outer periphery. In this case, if the holding member 30 is attached to the outer periphery of the belt-shaped unit 13 in a bent state, the holding member 30 acts against a force acting in a direction unmating the groove 27 and the protrusion 28 from each other at the outer periphery of the bent portion 26. This reduces the possibility that the groove 27 and the protrusion 28 will be unmated from each other.

FIG. 7 illustrates a belt-shaped unit 13 according to a third modification that includes tubular members 12. The tubular members 12 include a flat and wide protective tubular member 12B, which includes a groove 27 and a protrusion 28. The protective tubular member 12B accommodates fluid feeding hoses 31, which are long objects, and power feeding cables 15, which are also long objects. In this case, unmating a single pair of the groove 27 and the protrusion 28 allows the cables 15 and the hoses 31, which are long objects, to be replaced at one time.

The holding member 30 does not necessarily need to have a shape of an elongated plate with the hooks 30a being coupled together by the coupling portions 30b. For example, multiple holding members 30 that respectively include a hook 30a may be provided at separate positions in the longitudinal direction of the protective tubular members 12B.

The holding member 30 does not necessarily need to be attached to the mated grooves 27 and protrusions 28, which are formed on each protective tubular member 12B of the belt-shaped unit 13.

Among the tubular members 12 forming the belt-shaped unit 13, the tubular members 12 that are located on the opposite sides in the arrangement direction and accommodate the articulated supporting members 14 may be provided with the grooves 27 and the protrusions 28. That is, each of the supporting tubular members 12A, which are configured to accommodate the articulated supporting members 14, may be provided with the groove 27 and the protrusion 28.

The first joint portion and the second joint portion do not necessarily need to be the groove 27 and the protrusion 28, which are mated with each other. For example, the first joint portion and the second joint portion may be strips of a hook-and-loop fastener that are provided in overlapping end portions in the circumferential direction of each protective tubular member 12B. The strips are joined together while being in planar contact with each other.

### REFERENCE SIGNS LIST

11 . . . Long Object Guiding Device; 12 . . . Tubular Member; 12A . . . Supporting Tubular Member; 12B . . . Protective Tubular Member; 13 . . . Belt-Shaped Unit; 13a . . . First End Portion; 13b . . . Second End Portion; 14 . . . Articulated Supporting Member: 15 . . . Cable, which is a Long Object; 26 . . . Bent Portion; 27 . . . Groove; 28 . . . Protrusion; 30 . . . Holding Member; X . . . Guiding Direction

1. A long object guiding device, comprising a belt-shaped unit that includes flexible and elongated tubular members, the tubular members being arranged side by side, and adjacent ones of the tubular members being coupled together so that all the tubular members are integrated, wherein
the long object guiding device is configured to
accommodate a flexible long object in at least one of the tubular members, and
guide the long object while protecting the long object with the tubular member as the belt-shaped unit is displaced, wherein
the tubular members include at least one protective tubular member,
the protective tubular member is configured to accommodate the long object, and the protective tubular member includes:
a first joint portion that is formed to extend in a longitudinal direction of the protective tubular member; and
a second joint portion that is formed to extend in the longitudinal direction, the second joint portion being configured to be joined to and disjoined from the first joint portion.

2. The long objective guiding device according to claim 1, wherein
the first joint portion is a groove that extends in the longitudinal direction, and
the second joint portion is a protrusion that extends in the longitudinal direction, the protrusion being configured to be mated with and unmated from the groove.

3. The long object guiding device according to claim 2, wherein
the belt-shaped unit includes a first end portion and a second end portion in a longitudinal direction of the belt-shaped unit,
the first end portion is a fixed end,
the second end portion is a movable end that moves in a guiding direction, the guiding direction being a direction in which the long object is guided while being protected by the protective tubular member,
the belt-shaped unit includes a bent portion between the first end portion and the second end portion, the bent portion being displaced in the guiding direction as the second end portion moves, and
the groove and the protrusion are provided in a part of the protective tubular member that is at an inner periphery of the bent portion.

4. The long object guiding device according to claim 2, wherein a holding member is attached to the protective tubular member, the holding member being engaged with the mated groove and protrusion so as to maintain a mated state of the groove and the protrusion.

5. The long object guiding device according to claim 4, wherein the holding member is an elongated member that extends in the longitudinal direction of the protective tubular member.

6. The long object guiding device according to claim 1, wherein
the tubular members include two supporting tubular members, the two supporting tubular members being located on opposite sides in an arrangement direction of the tubular members,
each supporting tubular member accommodates an articulated supporting member,
each articulated supporting member includes link members,
the link members are arranged in series, adjacent ones of the link members being pivotally coupled to each other,
each articulated supporting member is allowed to pivot toward one side in a direction intersecting with a series arrangement direction within a range up to a set bend radius, while being restricted from pivoting to an other side that is opposite to the one side, and
the tubular members, except for the supporting tubular members which are located on the opposite sides in the arrangement direction, include the at least one protective tubular member.
